(19) United States
(12) Patent Application Publication
(10) Pub. No.: US 2008/0023874 A1
(43) Pub. Date: Jan. 31, 2008

(54) Method for the Production of Fibres and Other Moulded Articles Comprising Cellulose Carbamate and/or Regenerated Cellulose

(76) Inventors: Hans-Peter Fink, Teltow (DE); Peter Weigel, Neuruppin (DE); Rainer Rihm, Berlin (DE)

Correspondence Address: Anthony J Zelano;Millen White Zelano & Branigan P C, 2200 Clarendo Boulevard, Suite 1400, Arlington, VA, 22201, US

(21) Appl. No.: 10/589,573

(22) PCT Filed: Feb. 17, 2005
(86) PCT No.: PCT/EP05/01642

§ 371 Date: Jun. 25, 2007

(30) Foreign Application Priority Data
Feb. 17, 2004 (DE) 10 2004 007 616.2

(51) Int. Cl. D01F 2/24; C08B 15/06; D01F 2/00

(52) U.S. Cl. 264/183; 264/178 R

(57) ABSTRACT

The invention relates to high-strength fibres and other moulded articles comprising cellulose carbamate or cellulose which is obtained by regeneration of cellulose carbamate, and also production thereof by extrusion of a solution of cellulose carbamate in N-methylmorpholine-N-oxide (NMMNO).

The invention relates to high-strength fibres and other moulded articles comprising cellulose carbamate or cellulose which is obtained by regeneration of cellulose carbamate, and also production thereof by extrusion of a solution of cellulose carbamate in N-methylmorpholine-N-oxide (NMMNO).

Cellulose fibres and moulded articles are produced predominantly according to the known viscose method. Because of the high environmental damage and considerable investment costs involved with this method, considerable efforts have been made already worldwide however for many years to replace the viscose method with alternative methods.

A known possibility for the production of moulded articles comprising regenerated cellulose resides in precipitation of a solution of cellulose carbamate (EP-A 57 105, EP-A 178 292), which is formed by conversion of cellulose with urea with thermal cleavage of the urea into isocyanic acid. Cellulose carbamate is soluble in cold dilute sodium hydroxide solution and can be regenerated back into cellulose in heated sodium hydroxide solution.

Another method, according to which inter alia the known “Lyocell” fibre is produced, resides in precipitation of a solution of cellulose in a system comprising N-methylmorpholine-N-oxide (NMMNO) and water (U.S. Pat. No. 3,767,756, DE 28 30 685), the solution being extruded into an aqueous regenerating bath via an air gap. The method has the disadvantage however relative to the viscose method of a relatively low variability of the product properties. Whilst fibre strengths of 15 to 60 cN/tex are achievable with the viscose method, in the NMMNO method, strengths are within a relatively narrow range between 30 to 45 cN/tex. Hence, the field of use of fibres of this type is greatly restricted because fibres with lower strength, which also have a lesser tendency to fibrillation, are preferred for the textile field, and for technical applications, frequently higher strengths are desired (e.g. for tyre cord).

It is therefore the object of the present invention to provide a method which is independent of the viscose method for the production of high-strength cellulose fibres and moulded articles. A further object with respect to the method resides in the method to be proposed fulfilling the requirements with respect to lower investment and production costs and less environmental damage.

This object is achieved by the method having the features of claim 1 and also the fibres or other moulded articles having the features of claim 11. The further dependent claims reveal advantageous developments.

According to the invention, a method for the production of fibres and other moulded articles is provided, in which a lyotropic solution of cellulose carbamate in N-methylmorpholine-N-oxide (NMMNO) is shaped by means of extrusion from at least one nozzle via an air gap into a regenerating bath.

Surprisingly, it appears that cellulose carbamate is also soluble in NMMNO and the solution can be spun into fibres or shaped into other moulded articles. Relative to the conventional NMMNO method, two advantageous differences are thereby revealed:

1. The viscosity of the conventional solutions increases greatly with increasing content of cellulose or cellulose carbamate. Too high a viscosity however impairs the spinnability of the solution. The limit of the spinnability is therefore, in the conventional cellulose solution, at a content of at most 15%. In contrast, this limit with cellulose carbamate in NMMNO is approx. 30%. Solutions with a content of cellulose carbamate of 25% can still be spun without problem. The higher concentration of the solution causes lower use of solvent and hence lower expense in the reprocessing of the regenerating bath in order to recover the NMMNO and thus leads to a significant cost reduction.

2. Solutions with a cellulose carbamate content of over 20% surprisingly reveal a lyotropic behaviour, i.e. the cellulose carbamate is present in a liquid-crystalline state, as is evident from polarising microscopic pictures. The extremely advantageous application is produced therefore that the molecules are orientated virtually perfectly in the fibre direction during spinning as a result of the shearing in the nozzle channel, the fibres thus have an extraordinarily high orientation and hence very high strength.

Variations in the level of orientation are achievable by changing the L/D ratio (ratio length/diameter of the nozzle channel) and of the drawing-off ratio (ratio drawing-off speed/nozzle outlet speed). Preferably L/D ratios of 1 to 20 and drawing-off ratios of preferably 5 to 200 are used. The width of the air gap between nozzle and regenerating bath is preferably 5 to 250 mm, particularly preferred 10 to 150 mm.

Preferably, the lyotropic solution is produced by swelling of the cellulose carbamate in a 50% solution of NMMNO in water and subsequent removal of the water up to a ratio of NMMNO to water between 80:20 and 90:10, particularly preferred 87:13. The spinning is effected preferably at a temperature of 80 to 110° C., particularly preferred in the range of 85 to 95° C.

The regenerating bath preferably comprises a solution of NMMNO in water with an NMMNO proportion of 0.5 to 25% by wt., particularly preferred 5 to 15% by wt., respectively relative to the regenerating bath solution.

In a further variant of the method according to the invention, the cellulose carbamate is regenerated into cellulose in a regenerating bath.

For particular preference, the cellulose carbamate is regenerated into cellulose in a regenerating bath comprising 0.3 to 1% by wt. sodium hydroxide in water at a temperature of 60 to 95° C.

According to the invention, likewise fibres and other moulded articles comprising cellulose carbamate and/or regenerated cellulose are provided, which have a strength of at least 60 cN/tex. Preferably, the fibres and other moulded articles can be produced according to the above-described method.

The subject according to the invention is intended to be explained in more detail with reference to the subsequent Figure and examples, without wishing to restrict said subject to these special embodiments.

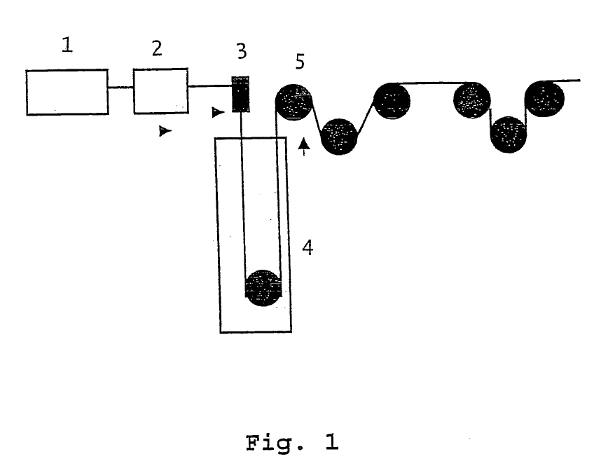

FIG. 1 shows a schematic representation of the course of the method according to the invention.

The basic course of the method is represented in FIG. 1. The spinning solution 1 is, hereby extruded into a regenerating bath 4 via a spinning pump 2 by means of a nozzle beam 3 which contains a multiplicity of nozzles. Spinning is thereby effected vertically from the top to the bottom via the air gap into the regenerating bath. The fibres are drawn off in the horizontal direction via deflection rollers 5.

### Example 1

(comparative example according to the state of the art)

A spinning solution of 9.5% cellulose in NMMO monohydrate with 0.5% by mass propyl gallate as stabiliser was spun in a laboratory spinning unit with a 40 hole nozzle at a temperature of 90° C., a 10% solution of NMMO in water being used as spinning bath (regenerating bath). The filament yarns had a strength of 35 cN/tex and a stretch of 9% with a titre of 8.0 tex.

### Example 2

250 g cellulose carbamate (3% nitrogen content, cuoxam DP 300) were mixed in a kneader with 1305 g of a 50% aqueous NMMO solution, this solution was concentrated up to NNMO monohydrate by withdrawing the excess water under a vacuum of 80 mbar and the cellulose carbamate was thereby dissolved. The spinning solution had a cellulose content of 25% by mass. This spinning solution was spun on a laboratory spinning unit with a 40 hole nozzle at a temperature of 100° C., a 10% solution of NMMO in water being used as spinning bath (regenerating bath). The filament yarns had a strength of 65 cN/tex and a stretch of 6% with a titre of 8.1 tex.

### Example 3

250 g cellulose carbamate (3% nitrogen content, cuoxam DP 300) were mixed in a kneader with 1305 g of a 50% aqueous NMMO solution, this solution was concentrated up to NNMO monohydrate by withdrawing the excess water under a vacuum of 80 mbar and the cellulose carbamate was thereby dissolved. The spinning solution had a cellulose content of 25% by mass. This spinning solution was spun on a laboratory spinning unit with a 40 hole nozzle at a temperature of 100° C., a 10% solution of NMMO in water being used as spinning bath (regenerating bath). The initially moist fibres were subjected to a subsequent treatment in 0.5% NaOH solution. The filament yarns had a strength of 69 cN/tex and a stretch of 4.5% with a titre of 7.6 tex.

1. Method for the production of fibres and other moulded articles, in which a lyotropic solution of cellulose carbamate in N-methylmorpholine-N-oxide (NMMNO) is shaped by means of extrusion from at least one nozzle via an air gap into a regenerating bath.

2. Method according to claim 1,
characterised in that the ratio of length to diameter of the nozzles is from 1 to 20.

3. Method according to one of the claims 1 or 2,
characterised in that the drawing-off ratio is in the range of 5 to 200.

4. Method according to one of the preceding claims,
characterised in that the width of the air gap between nozzle and regenerating bath is 5 to 150 mm, in particular 10 to 50 mm.

5. Method according to one of the preceding claims,
characterised in that the cellulose carbamate proportion of the lyotropic solution is at least 20% by wt., in particular 22 to 27% by wt., relative to the solution.

6. Method according to one of the preceding claims,
characterised in that the lyotropic solution is produced by swelling of the cellulose carbamate in a 40 to 70%, in particular 50% solution of NMMNO in water and subsequent removal of the water up to a ratio of NMMNO to water between 80:20 and 90:10.

7. Method according to one of the preceding claims,
characterised in that the regenerating bath comprises a solution of NMMNO in water with an NMMNO proportion of 0.5 to 25% by wt., in particular 5 to 15% by wt., relative to the solution.

8. Method according to one of the preceding claims,
characterised in that the extrusion is effected at a temperature between 80 to 110° C., in particular 85 to 95° C.

9. Method according to one of the preceding claims,
characterised in that the cellulose carbamate is regenerated into cellulose in a regenerating bath.

10. Method accordiing to the preceding claim,
characterised in that the regenerating bath comprises 0.3 to 1% by wt. sodium hydroxide in water and the regeneration is implemented at a temperature of 60 to 95° C.

11. Fibres or other moulded articles comprising cellulose carbamate and/or regenerated cellulose,
characterised in that the fibres or other moulded articles have a strength of at least 60 cN/tex.

12. Fibres or other moulded articles according to claim 12,
characterised in that the fibres or other moulded articles can be produced according to the method according to one of the claims 1 to 11.
